(19) United States
(12) Patent Application Publication
(10) Pub. No.: US 2010/0241690 A1
(43) Pub. Date: Sep. 23, 2010

(54) COMPONENT AND DEPENDENCY DISCOVERY

(75) Inventors: Venkata Seshu Kumar Kurapati, Bellevue, WA (US); Ilarie G. Letca, Redmond, WA (US); Dhananjay M. Mahajan, Sammamish, WA (US); Alexandre A. Coelho, Redmond, WA (US); Rajeev Sudhakar, Seattle, WA (US); Anandha K. Ganesan, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/407,793

(22) Filed: Mar. 20, 2009

(51) Int. Cl. G06F 15/16

(52) U.S. Cl. 709/203

(57) ABSTRACT

Methods, systems, and computer-readable media are disclosed for discovering components and dependencies in a distributed computing environment. A particular method includes discovering a first component and a second component of a distributed computing environment, where the first component and the second component are associated with different discoverable technologies. Each component is discovered based on a match between a characteristic of the component and a technology specification associated with the discoverable technology. The method also includes discovering a dependency between the first component and the second component.

### BACKGROUND

Enterprise software applications are often distributed across various physical components and may include various computer technologies. Because individual components may be added, removed, or modified, and since dependencies between components often change, staying current with a changing topology of a distributed application can be a challenge for information technology (IT) administrators. Furthermore, because the topology of a distributed application may change while the application is running, topological discovery preferably occurs at run-time.

Topological discovery generally involves two operations: discovering components that constitute a distributed application and discovering dependencies that may exist between the components. Although distributed application topologies may be heterogeneous, discovery systems are typically technology-specific (e.g., a certain system can discover Java-based components but not .NET-based components, while another system can discover dependencies between Windows-based components but not UNIX-based components). Thus, IT administrators often use multiple tools to keep track of distributed application components and dependencies. This may lead to inefficiencies in diagnosing and responding to errors that may occur at the distributed application. Furthermore, because the tools are technology-specific, they may not correctly discover inter-technology dependencies.

### SUMMARY

The present disclosure describes automatic discovery of components of a distributed computing environment (e.g., application components) and the discovery of dependencies between such components. Multiple discoverable technologies are supported, and each discoverable technology has an associated technology specification that defines characteristics of the discoverable technology. A first component, associated with a first discoverable technology, is discovered based on a match between a characteristic of the first component (e.g., a property included in metadata) and the technology specification of the first discoverable technology. Similarly, a second component, associated with a second discoverable technology, is discovered based on a match between a characteristic of the second component (e.g., a property included in metadata) and a technology specification of the second discoverable technology. One or more dependencies between the first component and the second component are also discovered. Dependencies between components may be discovered by attaching technology specific interceptors to the components and intercepting messages sent and received by each of the components.

Distributed components may include hardware, such as client computers, web servers, application servers, or database servers, or may include software such as web services. The plurality of discoverable technologies may include software technologies, such as Java, .NET, Windows-based technologies, UNIX-based technologies, Internet Information Services (IIS), and Windows Communication Foundation (WCF). Technology specifications associated with the plurality of technologies may be stored at a technology specification database, and discovery support for a new discoverable technology may be added by adding a technology specification for the new technology to the technology specification database. Discovered component information and discovered dependency information may be used to generate an end-to-end management view of a distributed application, enabling IT administrators to view each component and dependency information corresponding to the distributed application at a single location.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of a particular embodiment of a system to discover components and dependency information in a distributed computing environment;

FIG. 2 is a block diagram of another particular embodiment of a system to discover components and dependency information in a distributed computing environment;

FIG. 3 is a block diagram to illustrate message interception to discover dependencies in a distributed computing environment;

FIG. 4 is a flow diagram of a particular embodiment of a method of component and dependency discovery in a distributed computing environment;

FIG. 5 is a flow diagram of a particular embodiment of a method of creating a view of a distributed application;

FIG. 6 is an example of an end-to-end management view of a distributed computing environment;

FIG. 7 is a general diagram to illustrate a particular embodiment of a distributed computing environment; and

FIG. 8 is a block diagram of a computing environment including a computing device operable to support embodiments of computer-implemented methods, computer program products, and system components as illustrated in FIGS. 1-7.

### DETAILED DESCRIPTION

In a particular embodiment, a method is disclosed that includes discovering a first component of a distributed computing environment. The first component is associated with a first discoverable technology of a plurality of discoverable technologies. The first component is discovered based on a first match between a characteristic of the first component and a first technology specification. The first technology specification is associated with the first discoverable technology. The method also includes discovering a second component of the distributed computing environment. The second component is associated with a second discoverable technology that is different from the first discoverable technology. The second component is discovered based on a second match between a characteristic of the second component and a second technology specification. The second technology specification is associated with the second discoverable technology. The method also includes discovering a dependency between the first component and the second component.

In another particular embodiment, a system is disclosed that includes a discovery manager and a dependency manager. The discovery manager is configured to generate one or more crawlers, where each crawler is configured to discover one or more components of a distributed computing environment. The one or more components are discovered based on a comparison of metadata associated with the one or more components to a plurality of technology specifications. The discovery manager is further configured to initiate discovery of the one or more components by invoking the one or more crawlers. The dependency manager is configured to receive dependency data from a plurality of technology specific interceptors. Each technology specific interceptor is configured to discover dependencies of a particular component by intercepting messages sent to or received by the particular component. The discovery manager is further configured to send the dependency data to a persistent storage location.

In another particular embodiment, a computer-readable medium is disclosed. The computer-readable medium includes instructions, that when executed by a computer, cause the computer to discover a plurality of components of a distributed application by crawling metadata associated with the distributed application and by comparing the metadata to a plurality of technology specifications. Each component is associated with a particular technology of a plurality of technologies, and each of the plurality of technologies has an associated technology specification. The computer-readable medium also includes instructions, that when executed by the computer, cause the computer to generate discovery data based on the discovered components. For example, The computer-readable medium further includes instructions, that when executed by the computer, cause the computer to discover a dependency between a first component and a second component by intercepting messages between the first component and the second component at a technology specific interceptor. The computer-readable medium also includes instructions, that when executed by the computer, cause the computer to generate dependency data based on the discovered dependency between the first component and the second component. The computer-readable medium also includes instructions, that when executed by the computer, cause the computer to create a view of the distributed application based on the discovery data and based on the dependency data. The view identifies the discovered components, the technology associated with each of the discovered components, and the discovered dependency between the first component and the second component.

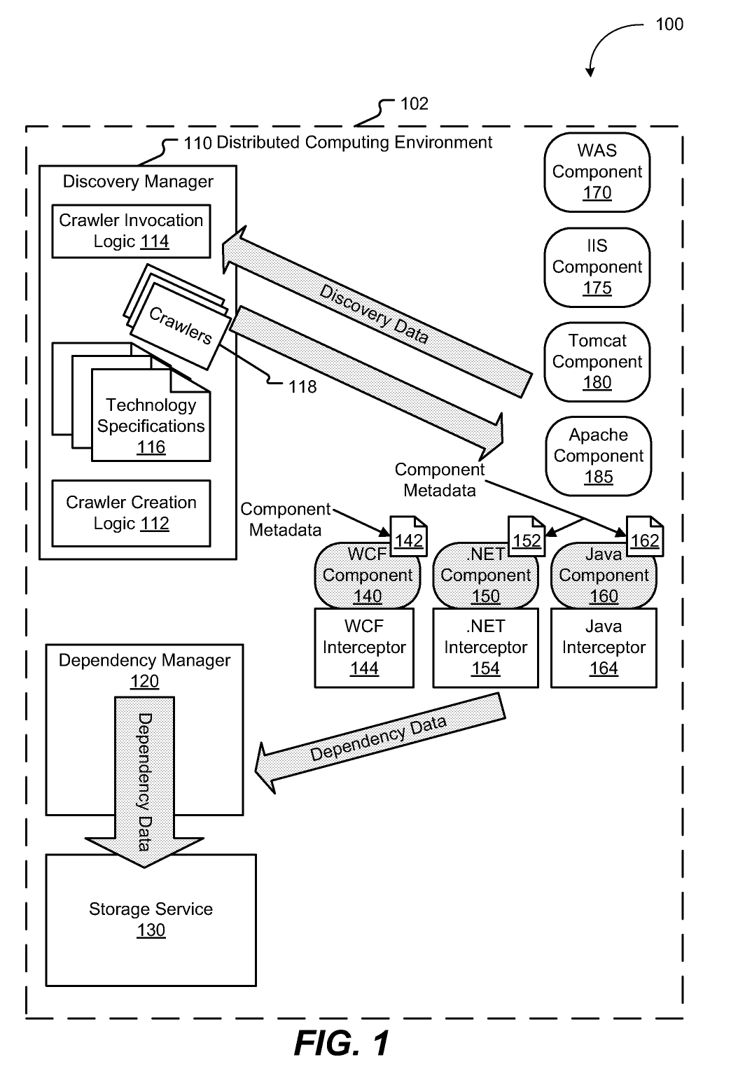

FIG. 1 is a block diagram of a particular embodiment of a system 100 to discover components and dependency information in a distributed computing environment 102. The distributed computing environment 102 includes a discovery manager 110 configured to discover one or more components (e.g., application components of the distributed computing environment 102), such as a WCF component 140, a .NET component 150, and a Java component 160, using one or more crawlers 118. The distributed computing environment 102 may also include other components, such as a Windows Activation Service (WAS) component 170, an Internet Information Services (IIS) component 175, a Tomcat component 180, and an Apache component 185. The distributed computing environment 102 also includes a dependency manager 120 configured to discover dependencies between components, such as dependencies between the WCF component 140, the .NET component 150, and the Java component 160, and to store dependency data via a storage service 130.

The discovery manager 110 may include crawler creation logic 112 and crawler invocation logic 114. The crawler creation logic 112 may be configured to create the one or more crawlers 118, and the crawler invocation logic 114 may be configured to initiate component discovery by invoking the one or more crawlers 118. Each of the crawlers 118 may be configured to discover components of the distributed computing environment 102 based on metadata (e.g., one or more configuration files) associated with the one or more components. The metadata associated with a particular component may include one or more characteristics of the particular component, such as structure of the particular component, a signature of the particular component, or a behavior of the particular component. The discovery manager 110 may also include a plurality of technology specifications 116, where each of the plurality of technology specifications 116 is associated with a particular technology. Each particular technology specification 116 may include one or more properties of the associated technology (e.g., component structures, component signatures, or component behaviors). Each particular technology specification 116 may also include at least one property associated with a technology standard that is applicable to the associated technology, such as web services description language (WSDL) software standard. In a particular embodiment, the crawlers 118 discover a particular component associated with a particular technology based on a match between metadata of the particular component (e.g., a signature of the particular component) and a technology specification associated with the particular technology (e.g., a component signature associated with the particular technology). In another particular embodiment, when the crawlers 118 discover a particular component, the crawlers 118 are further configured to send discovery data regarding the discovered component to the discovery manager 110. The discovery data regarding the discovered component may include one or more properties of the component, such as a location of the component, a name or other identifier associated with the component, an enterprise role of the component, and a discovered technology of the component.

In a particular embodiment, the crawler creation logic 112 may create each of the crawlers 118 by requesting the crawlers 118 from a crawler factory. The use of a crawler factory may allow design patterns (e.g. singleton crawlers or reusable crawlers) to be used during the creation of crawlers. The crawlers 118 and the crawler factory may be implemented in accordance with the following exemplary C# interfaces:

```
/// <summary>
/// Crawler Interface
/// </summary>
public interface ICrawler
{
    /// <summary>
    /// Crawl
    /// </summary>
    /// <returns>List of Deployments</returns>
    XmlElement[ ] Crawl( );
}
/// <summary>
/// Crawl Factory Interface
/// </summary>
public interface ICrawlFactory
{
    /// <summary>
    /// Get Crawler
    /// </summary>
    /// <param name=“id”>Crawler ID</param>
    /// <returns>Crawler</returns>
    ICrawler GetCrawler(string id);
}
```

It will be noted that when the crawlers 118 and the crawler factory are implemented in accordance with the above C# interfaces, the crawler creation logic 112 may create the crawlers 118 by calling the GetCrawler( ) method and the crawler invocation logic 114 may invoke the crawlers 118 by calling the Crawl( ) method.

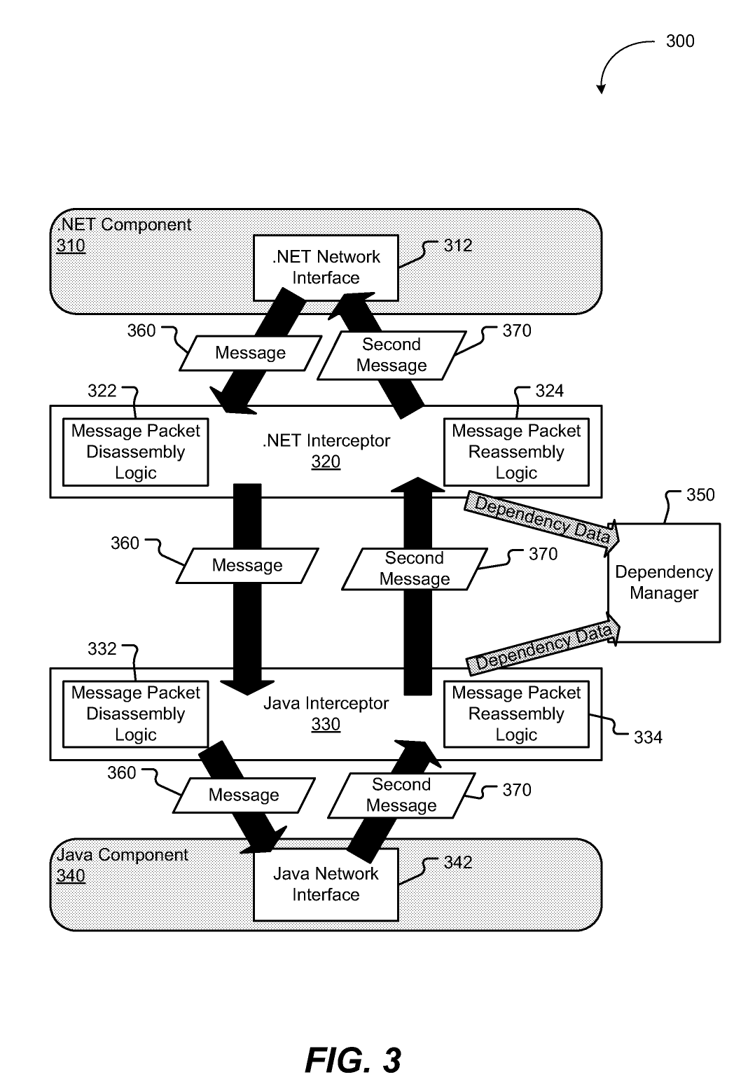

Components of the distributed computing environment 102 may have attached technology specific interceptors. For example, in the particular embodiment illustrated in FIG. 1, the WCF component 140 has an attached WCF interceptor 144, the .NET component 150 has an attached .NET interceptor 154, and the Java component 160 has an attached Java interceptor 164. In a particular embodiment, the dependency manager 120 attaches and detaches technology specific interceptors to each component. In another particular embodiment, technology specific interceptors are attached and detached independently of the system 100 of FIG. 1. Each technology specific interceptor may be configured to intercept messages sent by and received by the particular component that the technology specific interceptor is attached to. Each technology specific interceptor may also be configured to discover a dependency of the particular component based on the intercepted messages, to generate dependency data indicating the discovered dependency, and to send the generated dependency data to the dependency manager 120. Intercepting messages to generate dependency data is further described herein with reference to FIG. 3.

The dependency manager 120 may be configured to receive dependency data from technology specific interceptors, such as the WCF interceptor 144, the .NET interceptor 154, and the Java interceptor 164. The dependency manager 120 may also be configured to store the dependency data via the storage service 130. The storage service 130 may store the dependency data in a database or any other data store.

In a particular embodiment, the discovery manager 110 and the dependency manager 120 may be part of a discovery service that implements the following exemplary C# interface:

```
public interface IDiscoveryService
{
    XmlElement[ ] DoDiscovery(XmlElement parameterInformation);
    XMLElement[ ] DoDependencyDiscovery( );
}
```

It will be noted that when the discovery service is implemented in accordance with the above C# interface, component discovery by the dependency manager may be initialized by calling the DoDiscovery( ) method and dependency discovery by the dependency manager may be initialized by calling the DoDependencyDiscovery( ) method.

In operation, the crawler creation logic 112 may create the crawlers 118, where each of the crawlers 118 is configured to compare component metadata to a particular technology specification included in the plurality of technology specifications 116. For example, the crawler creation logic 112 may create a WCF metadata crawler to compare component metadata to a WCF technology specification, a .NET metadata crawler to compare component metadata to a .NET technology specification, and a Java metadata crawler to compare component metadata to a Java technology specification. The crawler invocation logic 114 may invoke each of the crawlers 118, and the crawlers 118 may traverse the distributed computing environment 102 in search of component metadata. Upon finding component metadata, the crawlers 118 may discover a component based on a match between the component metadata and a particular technology specification of the plurality of technology specifications 116. For example, the WCF metadata crawler may discover the WCF component 140 based on a match between the component metadata 142 and the WCF technology specification. Similarly, the .NET metadata crawler may discover the .NET component 150 based on a match between the component metadata 152 and the .NET technology specification, and the Java metadata crawler may discover the Java component 160 based on a match between the component metadata 162 and the Java technology specification. Each of the crawlers 118 may also send discovery data related to the discovered components to the discovery manager 110.

Once components in the distributed computing environment 102 have been discovered, the dependency manager 120 may receive dependency data related to the components from technology specific interceptors attached to the components. For example, the WCF interceptor 144 may discover a dependency between the WCF component 140 and the .NET component 150 by intercepting messages between the WCF component 140 and the .NET component 150. The WCF interceptor 144 may then send dependency data indicating the discovered dependency between the WCF component 140 and the .NET component 150 to the dependency manager 120. It should be noted that the same dependency may be discovered by intercepting the same messages at the .NET interceptor 144. It will thus be appreciated that a dependency between a source component and a target component may be discovered at either the source component or the target component.

When the dependency manager 120 receives dependency data from a technology specific interceptor, the dependency manager 120 may send newly discovered dependencies to the storage service 130. For example, the dependency manager 120 may send the discovered dependency between the WCF component 140 and the .NET component 150 to the storage service 130.

It should be noted that the discovery manager 110 and the dependency manager 120 may coexist on the same computing device. For example, the discovery manager 110 and the dependency manager 120 may coexist at a management server of the distributed computing environment 102. Alternatively, the discovery manager 110 and the dependency manager 120 may be implemented at different computing devices.

It will be appreciated that the system 100 of FIG. 1 may discover components (e.g., distributed application components) associated with various technologies in the distributed computing environment 102. It will also be appreciated that the system 100 of FIG. 1 may discover inter-component dependencies between the components associated with various technologies. Thus, the system 100 of FIG. 1 may provide a component and dependency discovery solution for heterogeneous distributed computing environments. Furthermore, it will be appreciated that the system 100 of FIG. 1 may be extended to support discovery of a new technology by adding a technology specification associated with the new technology to the plurality of technology specifications 116. Therefore, the system 100 of FIG. 1 may be used by IT administrators as a tool to stay current with topological changes in the distributed computing environment 102.

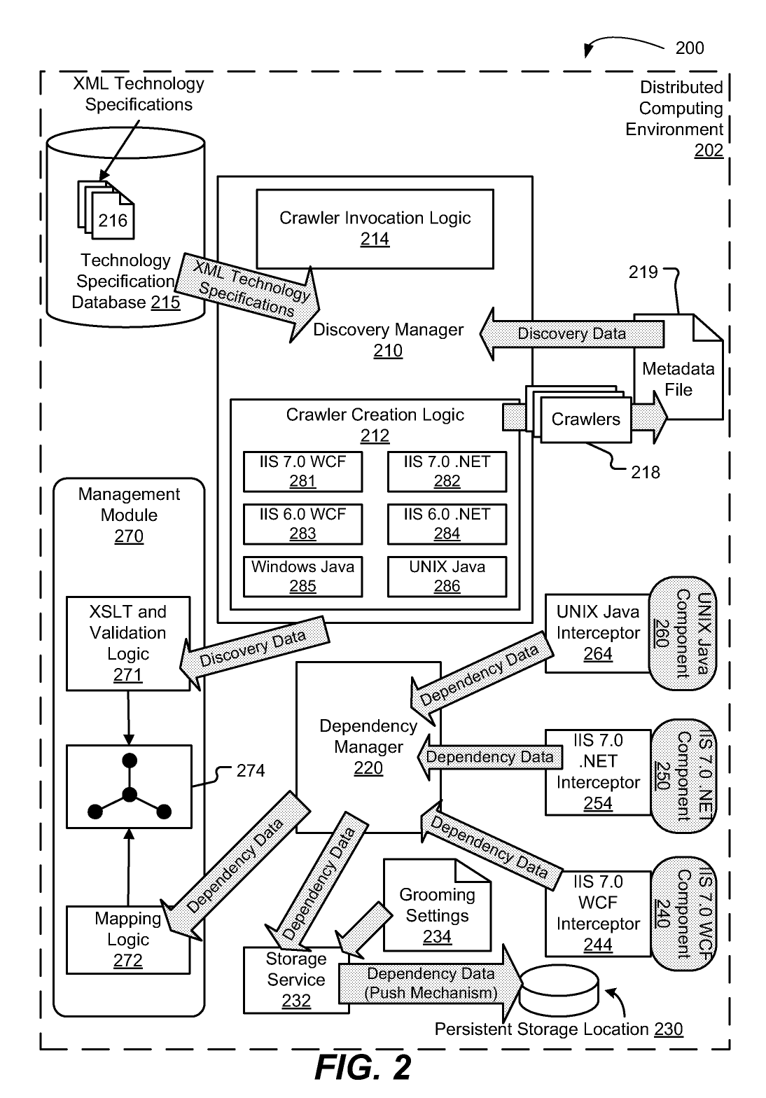

FIG. 2 is a block diagram of another particular embodiment of a system 200 to discover components and dependency information in a distributed computing environment 202. The distributed computing environment 202 includes a discovery manager 210 configured to send discovery data to a management module 270 and a dependency manager 220 configured to send dependency data to the management module 270. In an illustrative embodiment, the discovery manager 210 includes the discovery manager 110 of FIG. 1, and the dependency manager 220 includes the dependency manager 120 of FIG. 1.

The discovery manager 210 may include crawler creation logic 212 and crawler invocation logic 214. The crawler creation logic 212 may be configured to create one or more crawlers 218, and the crawler invocation logic 214 may be configured to initiate component discovery by invoking the one or more crawlers 218. In a particular embodiment, the crawler creation logic 212 is configured to create a metadata crawler for each discoverable technology in the distributed computing environment 202. Further, a different crawler may be created for each version of a particular discoverable technology. For example, the crawler creation logic 212 may create an Internet Information Services (IIS) 7.0 WCF crawler 281, an IIS 7.0. NET crawler 282, an IIS 6.0 WCF crawler 283, an IIS 6.0. NET crawler 284, a Windows Java crawler 285, and a UNIX Java crawler 286. The discovery manager 210 may also be configured to retrieve extensible markup language (XML) technology specifications 216 from a technology specification database 215 so that the crawlers 218 may compare crawled metadata to the XML technology specifications 216. For example, the XML technology specifications 216 may include XML technology specifications for IIS 7.0 WCF, IIS 7.0 .NET, IIS 6.0 WCF, IIS 6.0 .NET, Windows-based Java, and UNIX-based Java technologies.

In a particular embodiment, the crawlers 218 may be created in accordance with the following exemplary XML portion, where “CrawlerFactoryConfiguration” is a string identifying the particular type of crawler (e.g., one of the crawlers 281-286):

```
<xsd:schema
targetNamespace=“http://schemas.microsoft.com/mom/wsm/
CrawlerManagerConfiguration”
            elementFormDefault=“qualified”
            xmlns:xsd=“http://www.w3.org/2001/XMLSchema”
xmlns:wsm=“http://schemas.microsoft.com/mom/wsm/
CrawlerManagerConfiguration”>
  <xsd:element name=“CrawlerManagerConfiguration” >
    <xsd:complexType >
      <xsd:sequence>
        <xsd:element name=“AssemblyName” type=“xsd:string” />
        <xsd:element name=“Type” type=“xsd:string” />
        <xsd:element name=“CrawlerFactoryConfiguration”
type=“xsd:string” />
      </xsd:sequence>
    </xsd:complexType>
  </xsd:element>
</xsd:schema>
```

Each of the crawlers 218 may be configured to traverse the distributed computing environment 202 and to discover components based on metadata of the components. In a particular embodiment, the metadata of the components in the distributed computing environment 202 is located at a metadata file 219. In another embodiment, metadata for each particular component is located at the particular component. When the crawlers 218 discover a distributed application component, the crawlers 218 may be further configured to send discovery data regarding the discovered component to the discovery manager 210, and the discovery manager 210 may be further configured to send the received discovery data to the management module 270.

Components of the distributed computing environment 202 may be attached to technology specific interceptors. For example, in the particular embodiment illustrated in FIG. 2, an IIS 7.0 WCF component 240 has an attached IIS 7.0 WCF interceptor 244, an IIS 7.0. NET component 250 has an attached IIS 7.0. NET interceptor 254, and a UNIX Java component 260 has an attached UNIX Java interceptor 264. Each technology specific interceptor may be configured to discover a dependency of the particular component that the technology specific interceptor is attached to by intercepting messages sent and received by the particular component. Each technology specific interceptor may also be configured to generate dependency data indicating the discovered dependency and to send the generated dependency data to the dependency manager 220. Intercepting messages to generate dependency data is further described herein with reference to FIG. 3.

The dependency manager 220 may be configured to receive dependency data from technology specific interceptors, such as the technology specific interceptors 244, 254, and 264. The dependency manager 220 may also be configured to store the dependency data at a persistent storage location 230 via a storage service 232 and to send the dependency data to the management module 270. In a particular embodiment, the storage service 232 is a web service accessible by the dependency manager 220. In another particular embodiment, the storage service 323 is configured via a grooming settings file 234. The storage service 232 may store dependency data at the persistent storage location 230 via a push mechanism. For example, the storage service 232 may send a discovered dependency to the persistent storage location 230 upon determining that the discovered dependency has not previously been stored. The persistent storage location may continue to store dependencies for components even after the components are removed from the distributed computing environment 202. It should be noted that although only one persistent storage location 230 is illustrated in FIG. 2, data may be stored in multiple storage location. For example, a secondary storage location may be used for backup and data recovery purposes in the case of a failure of the persistent storage location 230.

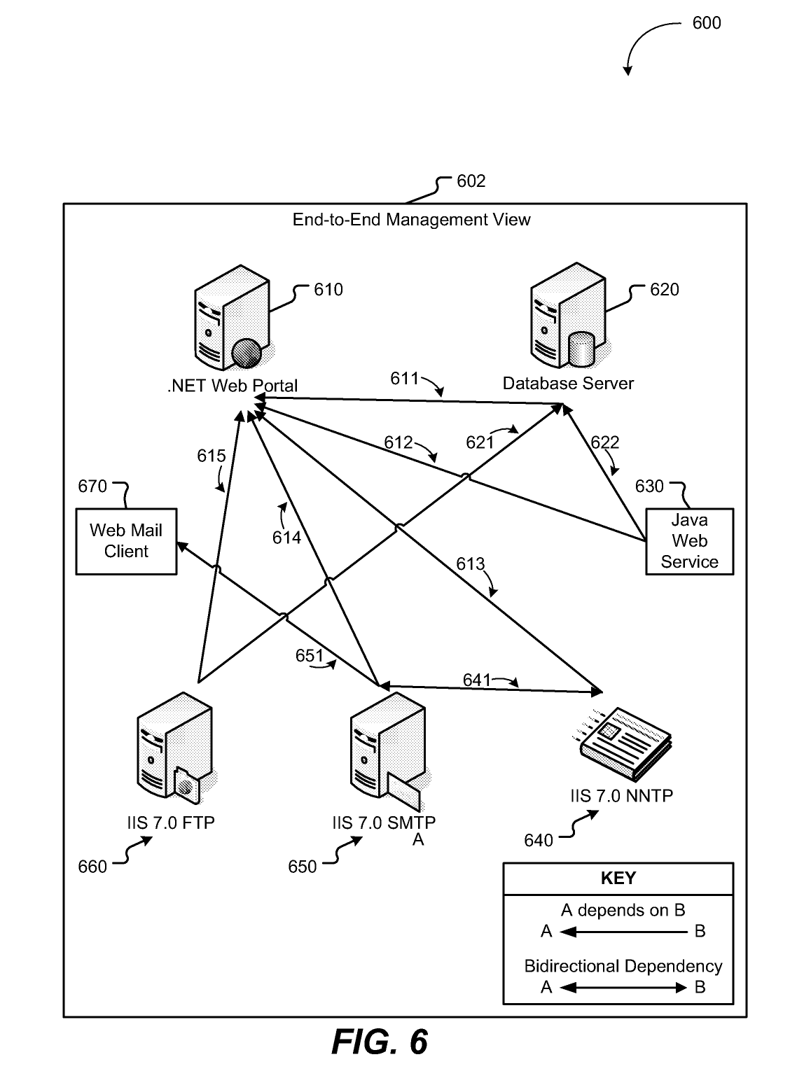

The management module 270 may be configured to receive discovery data from the discovery manager 210 and to receive dependency data from the dependency manager 220. The management module 270 may be further configured to transform the received discovery and dependency data into an end-to-end management view 274 of the distributed computing environment 202. In a particular embodiment, the received discovery data and the received dependency data is in XML format. In such an embodiment, the management module 270 may include extensible stylesheet language transformation (XSLT) and validation logic 271 to validate and transform the discovery data into the end-to-end management view 274. The management module 270 may also include mapping logic 272 to map discovered dependencies onto the end-to-end-management view 274. An example of an end-to-end management view of a distributed computing environment is further described herein with reference to FIG. 6.

In operation, the crawler creation logic 212 may create the crawlers 218, including the IIS 7.0 WCF crawler 281, the IIS 7.0. NET crawler 282, and the UNIX Java crawler 286. The crawler invocation logic 214 may invoke the crawlers 218, and the crawlers 218 may traverse the distributed computing environment 202 in search of component metadata. The discovery manager 210 may also retrieve the XML technology specifications 216 from the technology specification database 215, including an IIS 7.0 WCF XML technology specification, an IIS 7.0. NET XML technology specification, and a UNIX-based Java technology specification.

Upon locating the metadata file 219, the crawlers 218 may discover one or more distributed application components based on one or more matches between component metadata in the metadata file 219 and the XML technology specifications 216. For example, the IIS 7.0 WCF 281 crawler may discover the IIS 7.0 WCF component 240 based on a match between metadata of the component at the metadata file 219 and the IIS 7.0 WCF XML technology specification. As another example, the IIS 7.0 .NET crawler 282 may discover the IIS 7.0 .NET component 250 based on a match between metadata of the component at the metadata file 219 and the IIS 7.0 .NET XML technology specification. As yet another example, the UNIX Java crawler 286 may discover the UNIX Java component 260 based on a match between metadata of the component at the metadata file 219 and the UNIX-based Java technology specification. Each of the crawlers 218 may also send discovery data related to the discovered components (e.g., the components 240, 250, and 260) to the discovery manager 210, and the discovery manager 210 may send the received discovery data to the management module 270.

Once components in the distributed computing environment 202 have been discovered, the dependency manager 220 may receive dependency data related to the components from technology specific interceptors attached to the components. For example, the IIS 7.0 WCF interceptor 244 may discover a dependency between the IIS 7.0 WCF component 240 and the IIS 7.0 .NET component 250. The IIS 7.0 WCF interceptor 244 may then send dependency data indicating the discovered dependency to the dependency manager 220.

When the dependency manager 220 receives dependency data, the dependency manager 220 may send the dependency data to the storage service 232 that is responsible for storing discovered dependencies at the persistent storage location 230. The dependency manager 220 may also send the received dependency data to the management module 270.

The management module 270 may transform the received discovery data from the discovery manager 210 and the received dependency data from the dependency manager 220 to generate the end-to-end management view 274 of the distributed computing environment 202. When the discovery data and the dependency data are in XML format, the management module 270 may transform the discovery data at the XSLT and validation logic 271 to generate the end-to-end management view 274 and map the dependency data onto the end-to-end-management view using the mapping logic 272. In a particular embodiment, the management module 270 transforms and maps the data as it is received, so that the end-to-end management view 274 is generated in real-time or near real-time and depicts a real-time or near real-time topology of the distributed computing environment 202.

It will be appreciated that the system 200 of FIG. 2 provides centralized locations for technology specifications (e.g., the technology specification database 215) and component metadata (e.g. the metadata file 219), thereby simplifying the component discovery process. It will also be appreciated that by providing the storage service 232 that is responsible for storing dependencies, the system 200 of FIG. 2 reduces processing requirements at the dependency manager 220, because the dependency manager 220 does not need to maintain implementation details regarding the persistent storage location 230 (e.g., a network address of the persistent storage location 230 or specific communication protocols associated with the persistent storage location 230). Furthermore, when a particular component of the distributed computing environment 202 fails, the end-to-end management view 274 may be used by IT administrators to quickly identify dependencies of the failed component and to determine whether any of the dependencies caused or would be impacted by the failure.

FIG. 3 is a block diagram 300 to illustrate message interception to discover dependencies in a distributed computing environment (e.g., the distributed computing environment 102 of FIG. 1 or the distributed computing environment 202 of FIG. 2). In the particular embodiment illustrated in FIG. 3, messages are intercepted between a .NET component 310 and a Java component 340. The messages are intercepted at a .NET interceptor 320 attached to the .NET component 310 and at a Java interceptor 330 attached to the Java component 340. The .NET interceptor 320 and the Java interceptor 330 may also send dependency data to a dependency manger 350. In an illustrative embodiment, the .NET component 310 may include the .NET component 150 of FIG. 1 or the IIS 7.0 .NET component 250 of FIG. 2. The Java component 310 may include the Java component 160 of FIG. 1 or the UNIX Java component 260 of FIG. 2. The dependency manager 350 may include the dependency manger 120 of FIG. 1 or the dependency manager 220 of FIG. 2.

The .NET interceptor 320 may be attached to the .NET component 310 such that incoming and outgoing messages at the .NET component 310 pass through the .NET interceptor 320. For example, the .NET interceptor 320 may be attached at a .NET network interface 312 of the .NET component 310. The incoming and outgoing messages at the .NET component 310 may be XML messages or may be messages in any other message format. The .NET interceptor 320 may also be configured to discover a dependency of the .NET component 310 based on the incoming and outgoing messages and to send dependency data indicating the discovered dependency to the dependency manager 350. In a particular embodiment, the .NET interceptor 320 includes message packet disassembly logic 322 and message packet reassembly logic 324, so that message packets of each incoming and outgoing message may be broken down into packet subparts and each such subpart may be examined in detail.

Similarly, the Java interceptor 330 may be attached to the Java component 340 such that incoming and outgoing messages at the Java component 340 pass through the Java interceptor 330. For example, the Java interceptor 330 may be attached to a Java network interface 342 of the Java component 340. The incoming and outgoing messages at the Java component 340 may be XML messages or may be messages in any other message format. The Java interceptor 330 may also be configured to discover a dependency of the Java component 340 based on the incoming and outgoing messages and to send dependency data indicating the discovered dependency to the dependency manager 350. In a particular embodiment, the Java interceptor 330 includes message packet disassembly logic 332 and message packet reassembly logic 334, so that each incoming and outgoing message may be broken down into constitutive parts and each such part may be examined in detail.

In operation, the .NET component 310 may send a message 360 to the Java component 340. The message 360 may be sent from the .NET component 310 at the .NET network interface 312 and may be intercepted by the .NET interceptor 320 attached to the .NET network interface 312. Upon intercepting the message 360, the .NET interceptor 320 may examine the message 360, discover that a dependency exists between the .NET component 310 and the Java component 340 and send dependency data indicating the discovered dependency to the dependency manager 350. In a particular embodiment, the .NET interceptor 320 disassembles the message 360 at the message packet disassembly logic 332 and reassembles the message 360 at the message packet reassembly logic 324 in the course of examining the message 360, so that the message 360 is unchanged by the examination process. When the message 360 is an XML message, examining the message 360 may include performing an XML Path Language (XPATH) operation on the message 360 to identify that the message 360 is destined for the Java component 340. After examining the intercepted message 360, the .NET interceptor 320 may send the intercepted message 360 to the Java component 340.

Prior to arriving at the Java component 340, the message 360 may once again be intercepted, by the Java interceptor 330. The Java interceptor 330 may perform similar operations on the intercepted message 360 as described above with reference to the .NET interceptor 320. For example, the Java interceptor 330 may also discover a dependency between the .NET component 310 and the Java component 340 and may send dependency data indicating the discovered dependency to the dependency manager 350.

It should be noted that messages sent in either direction may be intercepted and examined to discover dependencies. For example, the dependency between the .NET component 310 and the Java component 340 may also be discovered by intercepting a second message 370 sent from the Java component 340 to the .NET component 310.

It should also be noted that although the particular embodiment illustrated in FIG. 3 shows an interceptor attached to both components, a dependency may be discovered between two components even when only one interceptor exists in a message path between the two components. For example, when the Java interceptor 330 is not present, the dependency between the .NET component 310 and the Java component 340 may nonetheless be discovered by the .NET interceptor 320. Similarly, when the .NET interceptor 320 is not present, the dependency between the .NET component 310 and the Java component 340 may nonetheless be discovered by the Java interceptor 330.

It will be appreciated that message interception to discover dependencies in a distributed computing environment, as illustrated in FIG. 3, may be used to discover dependencies between components associated with different technologies (e.g., .NET and Java). It will further be appreciated that technology specific interceptors, such as the .NET interceptor 320 and the Java interceptor 330, may include common functionality (e.g., functionality for sending dependency data to the dependency manager 350). When interceptors are software classes defined in object oriented fashion, such common functionality may be implemented in a technology agnostic interceptor base class that is inherited by technology specific interceptor derived classes, so that the common functionality does not have to be redefined by IT administrators each time a technology specific interceptor for a new technology is added to a distributed computing environment.

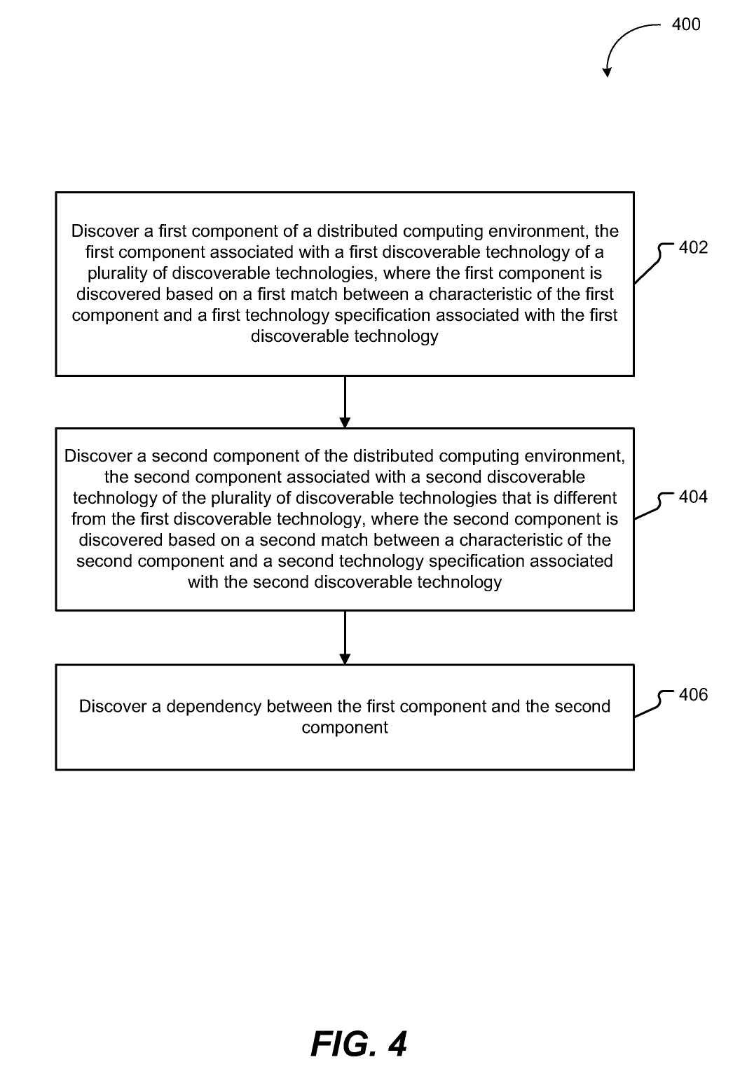

FIG. 4 is a flow diagram of a particular embodiment of a method 400 of component and dependency discovery in a distributed computing environment. In an illustrative embodiment, the method 400 may be performed at the distributed computing environment 102 of FIG. 1 or the distributed computing environment 202 of FIG. 2.

The method 400 includes discovering a first component of a distributed computing environment, at 402. The first component is associated with a first discoverable technology of a plurality of discoverable technologies. The first component is discovered based on a match between a characteristic of the first component and a first technology specification of a plurality of technology specifications. The first technology specification is associated with the first discoverable technology. For example, in FIG. 1, the crawlers 118 may discover the .NET component 150 based on a match between a characteristic of the .NET component 150 that is included in the component metadata 152 and a .NET technology specification that is included in the plurality of technology specifications 116.

The method 400 also includes discovering a second component of the distributed computing environment, at 404. The second component is associated with a second discoverable technology of a plurality of discoverable technologies. The second component is discovered based on a match between a characteristic of the second component and a second technology specification of the plurality of technology specifications. The second technology specification is associated with the second discoverable technology. For example, in FIG. 1, the crawlers 118 may discover the Java component 160 based on a match between a characteristic of the Java component 160 that is included in the component metadata 162 and a Java technology specification that is included in the plurality of technology specifications 116.

The method also includes discovering a dependency between the first component and the second component, at 406. For example, in FIG. 1, a dependency between the .NET component 150 and the Java component 160 may be discovered based on intercepting messages between the .NET component 150 and the Java component 160 at one or both of the .NET interceptor 154 and the Java interceptor 164. In a particular embodiment, the dependency may be discovered as described with reference to the .NET component 310 of FIG. 3 and the Java component 340 of FIG. 3.

It will be appreciated that the method 400 of FIG. 4 may be used to discover components in a distributed computing environment that are associated with various technologies. It will further be appreciated that the method 400 of FIG. 4 may by used to discover inter-component dependencies between the components associated with the various technologies. It will therefore be appreciated that the method 400 of FIG. 4 may provide a component and dependency discovery solution for heterogeneous distributed computing environments.

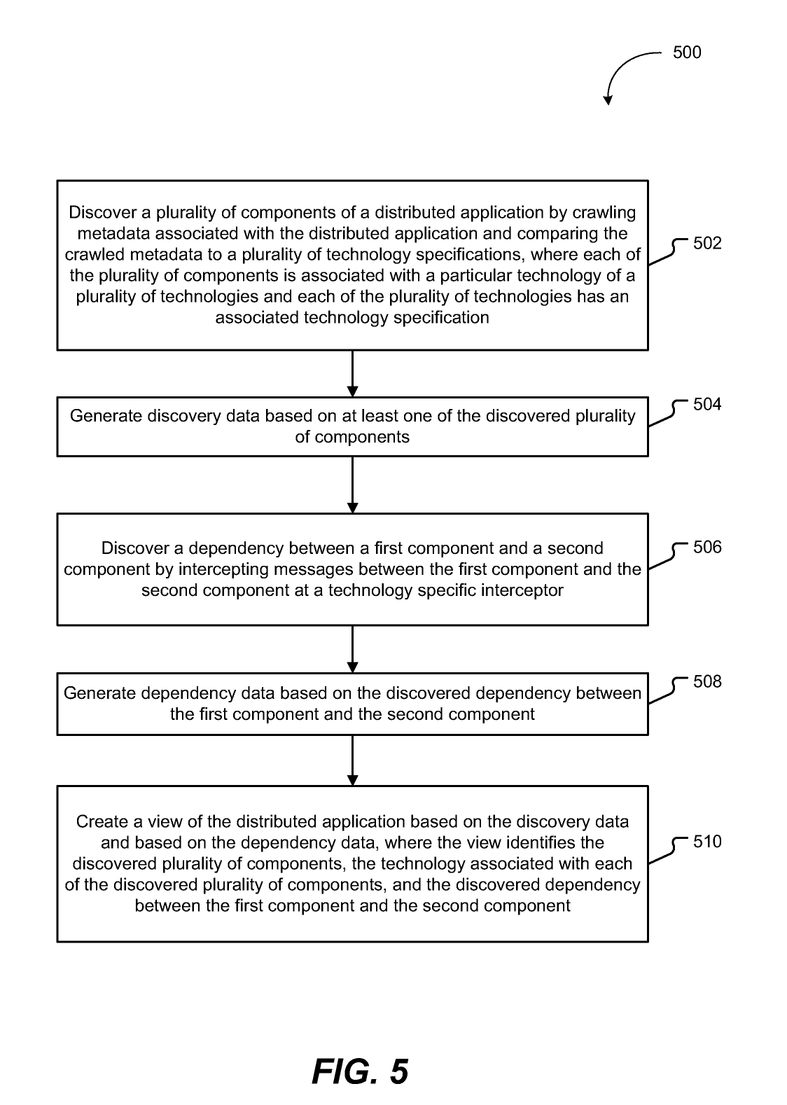

FIG. 5 is a flow diagram of a particular embodiment of a method 500 of creating a view of a distributed application. In an illustrative embodiment, the method 500 may be performed by the system 100 of FIG. 1 or the system 200 of FIG. 2.

The method 500 includes discovering a plurality of components of a distributed application by crawling metadata associated with the distributed application and comparing the crawled metadata to a plurality of technology specifications, at 502. Each component is associated with a particular technology of a plurality of technologies, and each technology has an associated technology specification. For example, in FIG. 2, the IIS 7.0 .NET component 250 and the UNIX Java component 260 may be discovered by the crawlers 218 based on matches between the metadata file 219 and XML technology specifications 216 for IIS 7.0 .NET and UNIX-based Java. The method 500 also includes generating discovery data based on the discovered plurality of components, at 504. For example, in FIG. 2, discovery data related to the discovered IIS 7.0 .NET component 250 and the discovered Unix Java component 260 may be generated by the crawlers 218 and may be sent to the discovery manager 210.

The method 500 further includes discovering a dependency between a first component and a second component, at 506. The dependency is discovered by intercepting messages between the first component and the second component at a technology specific interceptor. For example, in FIG. 2, a dependency between the IIS 7.0 .NET component 250 and the UNIX Java component 260 may be discovered by intercepting messages between the components 250 and 260 at one or both of the IIS 7.0 .NET interceptors 254 and the UNIX Java interceptor 264. In a particular embodiment, the dependency is discovered as described with reference to the .NET component 310 of FIG. 3 and the Java component 340 of FIG. 3. The method 500 also includes generating dependency data based on the discovered dependency between the first component and the second component, at 508. For example, in FIG. 2, dependency data indicating the discovered dependency between the IIS 7.0 .NET component 250 and the UNIX Java component 260 may be generated at the IIS 7.0 .NET interceptor 254 or the UNIX Java interceptor 264 and may be sent to the dependency manager 220.

The method further includes creating a view of the distributed application based on the discovery data and based on the dependency data, at 510. For example, in FIG. 2, the management module 270 may receive the discovery data from the discovery manager 210 and may receive dependency data from the dependency manager 220. The management module 270 may transform the received discovery data at the XSLT and validation logic 271 to create the end-to-end management view 274 and map the dependency data onto the end-to-end management view 274 using the mapping logic 272. For example, the management module may create the graphical end-to-end management view 602 of FIG. 6.

It will be appreciated that the method 500 of FIG. 5 may provide IT administrators with a graphical view of a distributed application, thereby reducing the time taken to diagnose and respond to failures of components of the distributed application. When a failure occurs at a particular component of the distributed application, the graphical view of the distributed application may be used to quickly identify the dependencies of the failed component and to determine whether any of the dependencies caused or are impacted by the failure.

FIG. 6 is an example 600 of an end-to-end management view 602 of a distributed computing environment (e.g., the distributed computing environment 102 of FIG. 1 or the distributed computing environment 202 of FIG. 2). In an illustrative embodiment, the end-to-end management view 602 may include the end-to-end management view 274 of FIG. 2.

The end-to-end management view 602 may include one or more discovered components, such as a .NET web portal 610, a database server 620, a Java web service 630, an IIS 7.0 network news transfer protocol (NNTP) application 640, an IIS 7.0 simple mail transfer protocol (SMTP) application 650, an IIS 7.0 file transfer protocol (FTP) application 660, and a web mail client 670. The end-to-end management view 602 may also include discovered dependencies between the discovered components, such as the dependencies 611, 612, 613, 614, 615, 621, 622, 641, and 651.

It will be appreciated that the end-to-end management view 602 of FIG. 6 may provide a graphical illustration of each component in a distributed computing environment, as well as each dependency of each component in the distributed computing environment. Thus, the end-to-end management view 602 of the distributed computing environment provides a single view of what components are present in the distributed computing environment and how the components relate to each other.

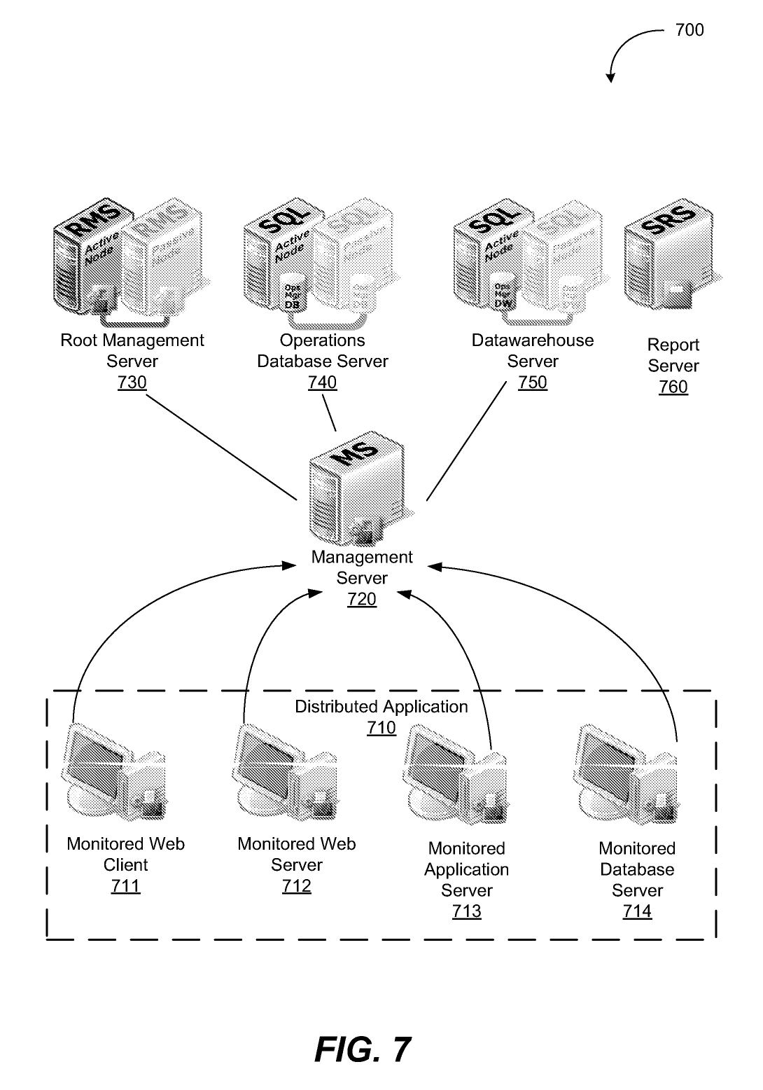

FIG. 7 is a general diagram to illustrate a particular embodiment of a distributed computing environment 700. The distributed computing environment 700 may include a distributed application 710 that includes one or more monitored application components, such as a monitored web client 711, a monitored web server 712, a monitored application server 713, and a monitored database server 714. The distributed computing environment 700 may also include a management server 720 communicatively coupled to the components of the distributed application 710 and a root management server 730, an operations database server 740, and a datawarehouse server 750. In a particular embodiment, the distributed computing environment 700 also includes a report server 760 configured to generate monitoring reports for the distributed application 710. In an illustrative embodiment, the distributed computing environment 700 may include the distributed computing environment 102 of FIG. 1 or the distributed computing environment 202 of FIG. 2.

The management server 720 includes a discovery manager, such as the discovery manager 110 of FIG. 1 or the discovery manager 210 of FIG. 2, and a dependency manager, such as the dependency manager 120 of FIG. 1 or the dependency manager 220 of FIG. 2. The management server 720 may also communicate with the root management server 730. The management server 720 may store and retrieve information, such as discovery and dependency data, from the operations database server 740 and the datawarehouse server 750. In a particular embodiment, the management server 720 is configured to generate monitoring reports that include discovery data and dependency data via the report server 760.

In operation, the discovery manager at the management server 720 may discover the monitored web client 711, the monitored web server 712, the monitored application server 713, and the monitored database server 714 by creating and invoking crawlers, such as the crawlers 118 of FIG. 1 or the crawlers 218 of FIG. 2. The monitored web client 711, the monitored web server 712, the monitored application server 713, and the monitored database server 714 may each be monitored by one or more attached technology specific interceptors, such as the technology specific interceptors 144, 154, or 164 of FIG. 1, the technology specific interceptors 244, 254, 264 of FIG. 2, or the technology specific interceptors 320 or 330 of FIG. 3. Each attached technology specific interceptor may send dependency data to the dependency manager at the management server 720. The management server 720 may then generate an end-to-end management view of the distributed application 710, such as the end-to-end management view 274 of FIG. 2 or the end-to-end-management view 602 of FIG. 6.

It will be appreciated that the management server 720 may discover different types of distributed application components (e.g., web clients, web servers, application servers, and database servers). It will also be appreciated that the management server 720 may discover dependencies between the different types of distributed application components.

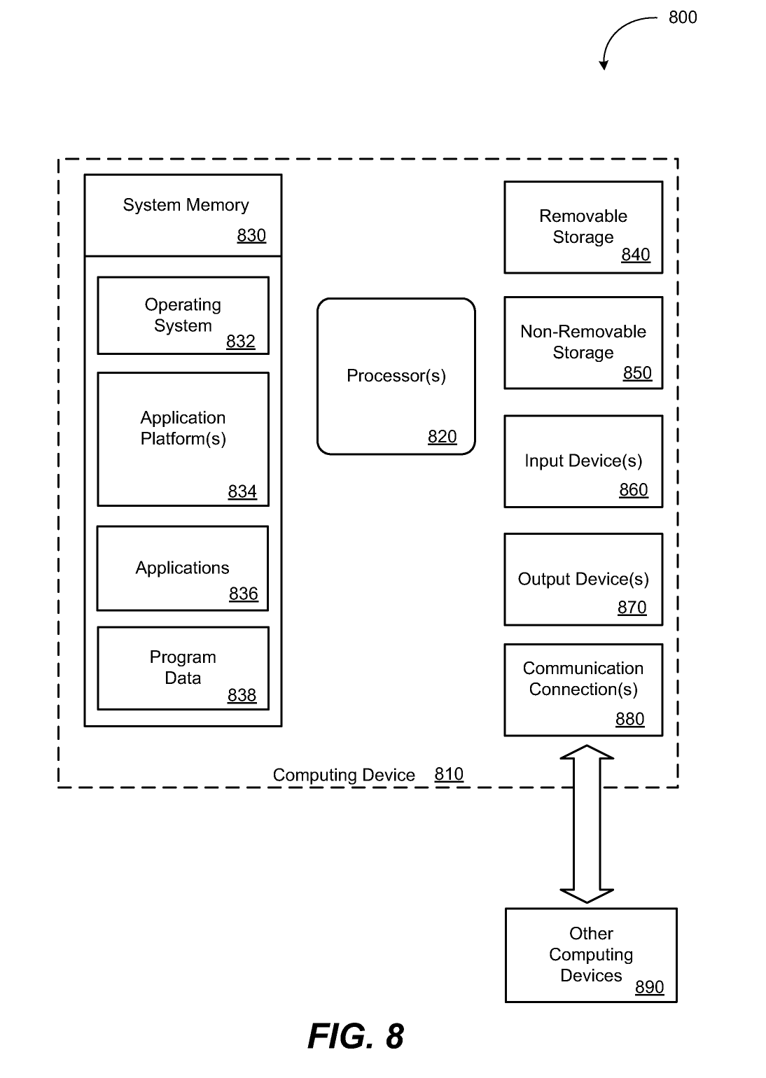

FIG. 8 shows a block diagram of a computing environment 800 including a computing device 810 operable to support embodiments of computer-implemented methods, computer program products, and system components according to the present disclosure.

The computing device 810 typically includes at least one processor 820 and system memory 830. Depending on the exact configuration and type of computing device, the system memory 830 may be volatile (such as random access memory or “RAM”), non-volatile (such as read-only memory or “ROM,” flash memory, and similar memory devices that maintain data stored even when power is not provided) or some combination of the two. The system memory 830 typically includes an operating system 832, one or more application platforms 834, one or more applications 836, and may include program data 838. For example, the system memory 830 may include the discovery manager 110 of FIG. 1, the discovery manager 210 of FIG. 2, the dependency manager 120 of FIG. 1, the dependency manager 220 of FIG. 2, or the management module 270 of FIG. 2. As another example, the computing device 810 may include the persistent storage location 230 of FIG. 2 or the technology specification database 215 of FIG. 2. The computing device 810 may include one or more components of a distributed application, such as the components 140, 150, 160, 170, 175, 180, or 185 of FIG. 1, the components 240, 250, or 260 of FIG. 2, the components 310 or 340 of FIG. 3, or the components 610, 620, 630, 640, 650, 660, or 670 of FIG. 6. When the computing device 810 includes a component, the computing device 810 may also include a technology specific interceptor attached to the component. For example, the computing device 810 may include the interceptors 144, 154, or 164 of FIG. 1, the interceptors 244, 254, or 264 of FIG. 2, or the interceptors 320 or 330 of FIG. 3.

In a particular embodiment, a distributed application environment (e.g., the distributed application environment 102 of FIG. 1 or the distributed application environment 202 of FIG. 2) may include multiple computing devices (e.g., the computing device 810), and each such computing device may include one or more components of the distributed computing environment.

The computing device 810 may also have additional features or functionality. For example, the computing device 810 may also include removable and/or non-removable additional data storage devices such as magnetic disks, optical disks, tape, and standard-sized or miniature flash memory cards. Such additional storage is illustrated in FIG. 8 by removable storage 840 and non-removable storage 850. Computer storage media may include volatile and/or non-volatile storage and removable and/or non-removable media implemented in any method or technology for storage of information such as computer-readable instructions, data structures, program components or other data. The system memory 830, the removable storage 840, and the non-removable storage 850 are all examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other medium that can be used to store the desired information and that can be accessed by the computing device 810. Any such computer storage media may be part of the computing device 810. The computing device 810 may also have input device(s) 860, such as a keyboard, mouse, pen, voice input device, touch input device, etc. Output device(s) 870, such as a display, speakers, printer, etc. may also be included.

The computing device 810 also contains one or more communication connections 880 that allow the computing device 810 to communicate with other computing devices 890, such as one or more client computing systems or other servers, over a wired or a wireless network. For example, the one or more communication connections 880 may include the network interfaces 312 or 342 of FIG. 3. The one or more communication connections 880 are an example of communication media. By way of example, and not limitation, communication media may include wired media such as a wired network or direct-wired connection, and wireless media such as acoustic, RF, infrared and other wireless media. It will be appreciated, however, that not all of the components or devices illustrated in FIG. 8 or otherwise described in the previous paragraphs are necessary to support embodiments as herein described.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor or the processor and the storage medium may reside as discrete components in a computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method comprising:
discovering a first component of a distributed computing environment, the first component associated with a first discoverable technology of a plurality of discoverable technologies, wherein the first component is discovered based on a first match between a characteristic of the first component and a first technology specification, the first technology specification associated with the first discoverable technology;
discovering a second component of the distributed computing environment, the second component associated with a second discoverable technology of the plurality of discoverable technologies that is different from the first discoverable technology, wherein the second component is discovered based on a second match between a characteristic of the second component and a second technology specification, the second technology specification associated with the second discoverable technology; and
discovering a dependency between the first component and the second component.

2. The method of claim 1, wherein the plurality of discoverable technologies includes Java, .NET, Unix-based technologies, Windows-based technologies, Internet Information Services (IIS), Windows Communication Foundation (WCF), or any combination thereof.

3. The method of claim 1, wherein the first technology specification comprises one or more properties associated with the first discoverable technology and the second technology specification comprises one or more properties associated with the second discoverable technology.

4. The method of claim 3, wherein at least one property associated with the first discoverable technology or at least one property associated with the second discoverable technology is associated with a technology standard.

5. The method of claim 1, wherein the first technology specification or the second technology specification is represented in extensible markup language (XML).

6. The method of claim 1, wherein the first match comprises a match between metadata associated with the first component and the first technology specification, the metadata associated with the first component including the characteristic of the first component; and wherein the second match comprises a match between metadata associated with the second component and the second technology specification, the metadata associated with the second component including the characteristic of the second component.

7. The method of claim 6, wherein the metadata associated with the first component includes metadata of one or more configuration files associated with the first component and the metadata associated with the second component includes metadata of one or more configuration files associated with the second component.

8. The method of claim 1, wherein discovering the dependency between the first component and the second component includes monitoring one or more messages between the first component and the second component.

9. The method of claim 8, wherein the one or more messages are monitored at a technology specific interceptor.

10. The method of claim 9, wherein the one or more messages comprise one or more packets and wherein monitoring the one or more messages includes disassembling and reassembling the one or more packets at the technology specific interceptor.

11. The method of claim 1, further comprising communicating dependency data related to the dependency between the first component and the second component to a storage service, wherein the storage service stores the dependency data to one or more storage locations.

12. The method of claim 11, wherein the dependency data is stored in response to determining that the dependency data includes data that has not been previously stored.

13. The method of claim 11, wherein the one or more storage locations include dependency data corresponding to a dependency of a component that has been removed from the distributed computing environment.

14. The method of claim 1, wherein a plurality of technology specifications are stored in a technology specification database, the method further comprising adding a new technology to the plurality of discoverable technologies by adding a new technology specification associated with the new technology to the technology specification database.

15. A system comprising:
a discovery manager configured to:
generate one or more crawlers, wherein each crawler is configured to discover one or more components of a distributed computing environment based on a comparison of metadata associated with the one or more components to a plurality of technology specifications; and
initiate discovery of the one or more components of the distributed computing environment by invoking the one or more crawlers; and
a dependency manager configured to:
receive dependency data from a plurality of technology specific interceptors, wherein each technology specific interceptor is configured to discover dependencies of a particular component of the distributed computing environment by intercepting messages sent or received by the particular component of the distributed computing environment; and
send dependency data to a storage service.

16. The system of claim 15, wherein the discovery manager is further configured to send discovery data to a management module, wherein the dependency manager is further configured to send the dependency data to the management module, and wherein the management module is configured to generate a management view of the distributed computing environment based on the discovery data and based on the dependency data.

17. The system of claim 16, wherein the discovery data and the dependency data are represented in extensible markup language (XML), and wherein generating the management view includes performing an extensible stylesheet language transformation (XSLT) on the discovery data and mapping the dependency data onto the management view.

18. A computer-readable medium comprising instructions, that when executed by a computer, cause the computer to:
discover a plurality of components of a distributed application by crawling metadata associated with the distributed application and comparing the crawled metadata to a plurality of technology specifications, wherein each of the plurality of components is associated with a particular technology of a plurality of technologies and wherein each of the plurality of technologies has an associated technology specification of the plurality of technology specifications;
generate discovery data based on at least one of the discovered plurality of components;
discover a dependency between a first component and a second component by intercepting messages between the first component and the second component at a technology specific interceptor;
generate dependency data based on the discovered dependency between the first component and the second component; and
create a view of the distributed application based on the discovery data and based on the dependency data, wherein the view identifies the discovered plurality of components, the technology associated with each of the discovered plurality of components, and the discovered dependency between the first component and the second component.

19. The computer-readable medium of claim 18, wherein the view of the distributed application is a graphical view.

20. The computer-readable medium of claim 18, wherein the plurality of components includes a web service, a web client, a web server, an application server, a database server, or any combination thereof.
